(19) United States
(12) Patent Application Publication
(10) Pub. No.: US 2006/0177680 A1
(43) Pub. Date: Aug. 10, 2006

(54) Polarizer and the manufacturing method thereof

(76) Inventors: Kuang-Rong Lee, Ping Chen City (TW); Ying-Da Tzeng, Ping Chen City (TW); Ming-Jian Shao, Ping Chen City (TW); Yi-Jen Lin, Ping Chen City (TW); Bor-Ping Wang, Ping Chen City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/209,824

(22) Filed: Aug. 24, 2005

(30) Foreign Application Priority Data
Feb. 5, 2005 (TW) 94104059

(51) Int. Cl. B32B 23/08; B32B 27/32; B05D 5/06

(52) U.S. Cl. 428/509; 428/523; 427/163.1

(57) ABSTRACT

A polarizer has an inner protection layer, an outer protection layer and a polarizing layer. A material of the inner protection layer comprises a blended cyclic olefin copolymer (COC), of which a blending ratio of cycloalkene monomer to ethylene determines the mechanical properties of the inner protection layer. The polarizing layer is positioned between the inner protection layer and the outer protection layer.

### RELATED APPLICATIONS

The present application is based on, and claims priority from, Taiwan Application Serial Number 94104059, filed Feb. 5, 2005, the disclosure of which is hereby incorporated by reference herein in its entirety.

### BACKGROUND

1. Field of Invention

The present invention relates to a method for manufacturing polarizers. More particularly, the present invention relates to polarizers for flat displays and the manufacturing method thereof.

2. Description of Related Art

Liquid crystal displays (LCD) have many advantages over other conventional types of displays including high display quality, small volume, light weight, low driving voltage and low power consumption. Hence, LCDs are widely used in small portable televisions, mobile telephones, video recording units, notebook computers, desktop monitors, projector televisions and the like, and have gradually replaced the conventional cathode ray tube (CRT) as a mainstream display unit.

In an LCD, polarizers are main elements for the display panel thereof. An LCD usually has an upper polarizer and a lower polarizer. FIG. 1 is a schematic view of a conventional upper polarizer. As illustrated in FIG. 1, an upper polarizer 100 has an inner protection layer 106, an outer protection layer 104 and a polarizing layer 102. The outer protection layer 104 is closest to the user, and the inner protection layer 106 is used to adhere to the display panel. The polarizing layer 102 is positioned between the inner protection layer 106 and the outer protection layer 104. Generally, the lower polarizer is similar in structure to the upper polarizer. The differences between the upper and lower polarizers are that the outer protection layer of the lower polarizer is used to adhere to a backlight source, and the inner protection layer of the lower polarizer is used to adhere to the display panel.

In the prior art, the material of the protection layers 104 and 106 is triacetyl cellulose (TAC), and the material of the polarizing layer 102 is polyvinyl alcohol (PVA), which easily absorbs moisture. The protection layers 104 and 106 prevent the polarizing layer 102 from absorbing moisture and protect it from contamination and physical damage. If the polarizing layer 102 absorbs moisture, it varies in size such that the polarizing characteristic is changed, and thus causes color shifting or light leakage of the display.

However, the triacetyl cellulose (TAC), which comprises the protection layers 104 and 106, is not very able to prevent moisture from passing through it. When a polarizer having TAC protection layers is used under an environment of high temperature and high humidity, the polarizing layer of the polarizer is easily affected by the outer environment such that its polarization is changed. Moreover, TAC is expensive, has an unstable supply, and has an undesirable optical performance because of its great photoelastic coefficient.

### SUMMARY

It is therefore an aspect of the present invention to provide a polarizer, whose protection layer contains blended cyclic olefin copolymer, to enhance the ability to prevent moisture intrusion and to improve the optical characteristics of the polarizer.

According to one preferred embodiment of the present invention, the polarizer has an inner protection layer, an outer protection layer and a polarizing layer. A material of the inner protection layer comprises a blended cyclic olefin copolymer (COC), of which a blending ratio of cycloalkene monomer to ethylene determines the mechanical properties of the inner protection layer. The polarizing layer is positioned between the inner protection layer and the outer protection layer.

It is another aspect of the present invention to provide a method for manufacturing a polarizer, in which blended cyclic olefin copolymers are used to improve the mechanical properties of the protection layer and to enhance the ability of the polarizer to prevent the moisture intrusion.

According to another preferred embodiment of the present invention, a blended cyclic olefin copolymer is selected, and the blended cyclic olefin copolymer has a blending ratio of cycloalkene monomer to ethylene. The blended cyclic olefin copolymer is made into an inner protection layer. The inner protection layer is adhered to a side of a polarizing layer.

It is to be understood that both the foregoing general description and the following detailed description are examples and are intended to provide further explanation of the invention as claimed.

### BRIEF DESCRIPTION OF THE DRAWINGS

These and other features, aspects and advantages of the present invention will become better understood with regard to the following description, appended claims and accompanying drawings where:

FIG. 1 is a schematic view of a conventional upper polarizer;

FIG. 2A is a schematic view of one preferred embodiment of the present invention;

FIG. 2B is a schematic view of another preferred embodiment of the present invention;

FIG. 2C is a schematic view of another preferred embodiment of the present invention; and

FIG. 3 is a flow chart of a manufacturing method of one preferred embodiment of the present invention.

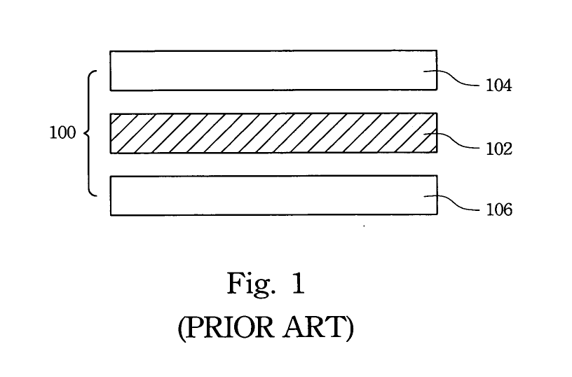

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention obtains a polarizer of low photoelastic coefficient, high transparency, high humidity resistance and good size stability to temperature and humidity variations, by selecting a blended cyclic olefin copolymer having a blending ratio of cycloalkene monomer to ethylene to be the material of the protection layer.

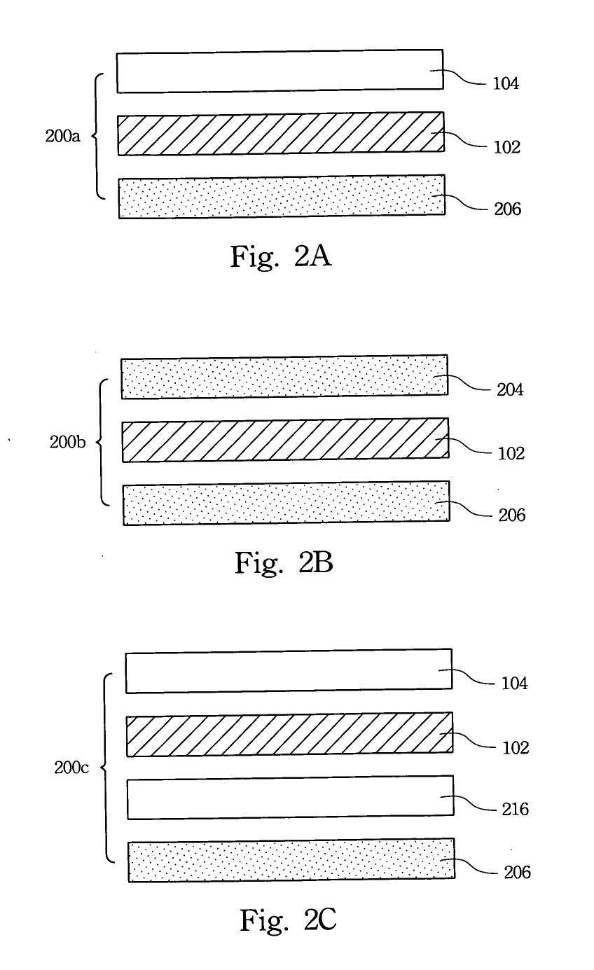

FIG. 2A is a schematic view of one preferred embodiment of the present invention. A polarizer 200a has an inner protection layer 206, an outer protection layer 104 and a polarizing layer 102. More precisely, the polarizer 200a can be an upper polarizer or a lower polarizer, wherein the inner protection layer 206 is defined as one nearest to the display panel, and the outer protection layer 104 is defined as one farthest from the display panel (e.g. near users or near the backlight source).

A material of the inner protection layer 206 comprises a blended cyclic olefin copolymer (COC), of which a blending ratio of cycloalkene monomer to ethylene determines the mechanical properties of the inner protection layer 206. The polarizing layer 102 is positioned between the inner protection layer 206 and the outer protection layer 104.

Cyclic olefin copolymer offers good moisture protection since it does not absorb much moisture and does not allow moisture permeation. Due to its high transparency and low birefringence, cyclic olefin copolymer also has excellent optical characteristics, such as equal wavelength distribution and good optical isotropy. Additionally, cyclic olefin copolymer is highly temperature resistant. In other words, the inner protection layer 206 can protect the polarizing layer 102 of the polarizer 200a such that it stably retains its size even in high-temperature and high-humidity environments.

Moreover, cyclic olefin copolymer can be processed to expand its functionality. For example, extending the cyclic olefin copolymer can make it have retardation for a phase difference, such as when applied to the inner protection layer 206 by an extending step to add optical compensation functionality. In practical applications, one or both of the inner protection layers 206 of the upper polarizer and lower polarizer can be selectively extended based on requirements and conditions. That is, the preferred embodiment is not limited to the optical compensation functionality being added to the upper polarizer or the lower polarizer. The manufacturer can selectively extend the protection layer, which is near the display panel (i.e. the inner protection layer 206), of the upper polarizer or the lower polarizer.

In another aspect, when the foregoing polarizer 200a is an upper polarizer, the material of the outer protection layer 104 can be triacetyl cellulose (TAC). Other treating steps can be applied to the outer protection layer 104, making its surface or body have other functions, such as anti-glare, hard-coat, low-reflection, anti-static, scratch-resistant, anti-pollution and wide-viewing functions. Therefore, the polarizer 200a can simultaneously offer the polarizing function along with many of the foregoing functions.

Besides the single protection layer of blended cyclic olefin copolymer, the present invention further provides another preferred embodiment, of which the protection layers positioned on two sides of the polarizing layer both are of blended cyclic olefin copolymers, thus further improving the ability to prevent moisture intrusion.

FIG. 2B is a schematic view of another preferred embodiment of the present invention. A polarizer 200b has an inner protection layer 206, an outer protection layer 204 and a polarizing layer 102. A material of the inner protection layer 206 comprises a blended cyclic olefin copolymer (COC), of which a blending ratio of cycloalkene monomer to ethylene determines the mechanical properties of the inner protection layer 206. A material of the outer protection layer 204 comprises a blended cyclic olefin copolymer (COC), of which a blending ratio of cycloalkene monomer to ethylene determines the mechanical properties of the outer protection layer 204. The polarizing layer 102 is positioned between the inner protection layer 206 and the outer protection layer 204.

According to the preferred embodiment, the blended cyclic olefin copolymers of the inner protection layer and the outer protection layer are of the same blending ratio, thus obtaining better mechanical properties. Alternatively, according to different conditions on the two sides of the polarizer 200b, the blended cyclic olefin copolymers of the inner protection layer and the outer protection layer are of different blending ratios, for adapting to the condition on each side.

FIG. 2C is a schematic view of another preferred embodiment of the present invention. A polarizer 200c of this preferred embodiment and the polarizer 200a as illustrated in FIG. 2A are different in that a triacetyl cellulose protection layer 216 is added between the inner protection layer 206 and the polarizing layer 102. In other words, the preferred embodiment adheres the outer protection layer 104 and the triacetyl cellulose protection layer 216 onto the two sides of the polarizing layer 102, and then adheres the inner protection layer 206, comprising the blended cyclic olefin copolymer, onto the triacetyl cellulose protection layer 216. Similarly, the mechanical properties of the inner protection layer 206 are determined by the blending ratio of cycloalkene monomer to ethylene of the blended cyclic olefin copolymer.

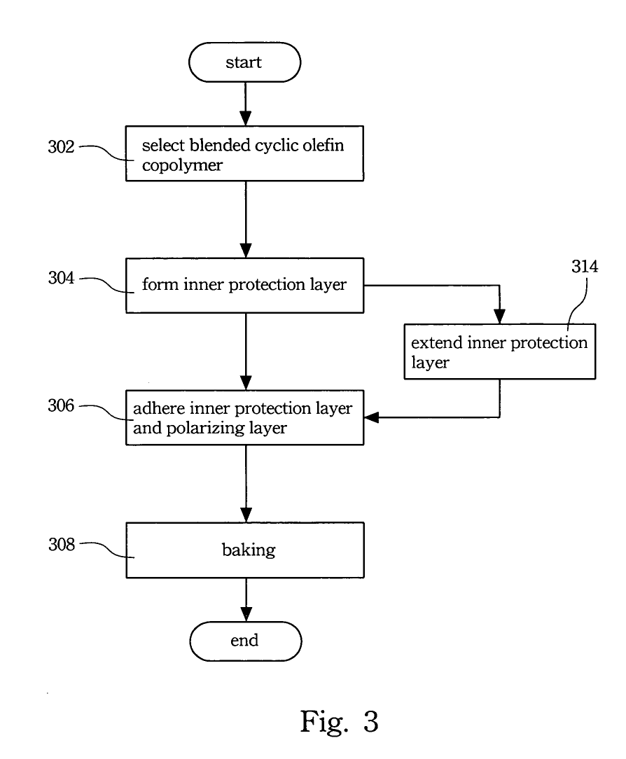

FIG. 3 is a flow chart of a manufacturing method of one preferred embodiment of the present invention. A blended cyclic olefin copolymer is selected (step 302), and the blended cyclic olefin copolymer has a blending ratio of cycloalkene monomer to ethylene. The blended cyclic olefin copolymer is made into an inner protection layer (step 304). The inner protection layer is adhered to a first side of a polarizing layer (step 306). Then, the polarizer comprising the foregoing inner protection layer and the polarizing layer is backed (step 308). The inner protection layer can be extended (step 314) such that the inner protection layer has retardation for a phase difference for optical compensation.

Another outer protection layer can be adhered to a second side of the polarizing layer. A material of the outer protection layer can comprise triacetyl cellulose. Alternatively, the material of the outer protection layer can comprise blended cyclic olefin copolymer, and its blending ratio can be the same as or different from that of the inner protection layer. Moreover, as mentioned above, an outside surface of the outer protection layer can be treated by a surface treatment, such as an anti-glare treatment, an anti-reflection treatment, a hard-coat treatment, other suitable treatments or their combinations.

Experimental results of one preferred embodiment are listed below to illustrate that the polarizer and the manufacturing method of the present invention have good waterproofing ability and optical characteristics. In this preferred embodiment, as illustrated in FIG. 2A, the material of the inner protection layer 206 is blended cyclic olefin copolymer (COC), and the thickness thereof is 90 μm; the material of the outer protection layer 104 is triacetyl cellulose (TAC), and the thickness thereof is 80 μm; and the material of the polarizing layer 102 is polyvinyl alcohol (PVA). Tables 1-5 separately list the moisture permeabilities of the protection layers, and the polarizing properties and MD/TD shrinkages of the PVA under different test environments.

TABLE 1
A comparison of the moisture permeabilities of the TAC and
COC protection layers, under a test environment with a
temperature of 40° C. and a humidity of 99% for 24 hours.
Moisture permeability (g/m²)

| TAC | COC |
|---|---|
| 282.9 | 1.76 |

TABLE 2
Heat resistance of the polarizer, under a test environment with a
temperature of 80° C. for 1000 hours.

| Polarizing characteristics | | | |
|---|---|---|---|
| Transparency/Variation | Polarization/Variation | Shrinkage (%) | |
| (%) | (%) | MD | TD |
| 41.848/−0.904 | 99.802/−0.154 | 0.28 | 0.52 |

TABLE 3
Humidity resistance of the polarizer, under a test environment
with a temperature of 60° C. and a humidity of 90% for
1000 hours.

| Polarizing characteristics | | | |
|---|---|---|---|
| Transparency/Variation | Polarization/Variation | Shrinkage (%) | |
| (%) | (%) | MD | TD |
| 43.474/0.847 | 99.734/−0.219 | 0.65 | 1.07 |

TABLE 4
Cold resistance of the polarizer, under a test environment with a
temperature of −30° C. for 1000 hours.

| Polarizing characteristics | | | |
|---|---|---|---|
| Transparency/Variation | Polarization/Variation | Shrinkage (%) | |
| (%) | (%) | MD | TD |
| 42.325/−0.286 | 99.946/−0.012 | 0.33 | 0.54 |

TABLE 5
Cyclical temperature resistance of the polarizer, under an
alternating cold-hot environment, wherein the polarizer is
cycled 100 times between a temperature of −30° C.
(for 30 minutes) and a temperature of 80° C. (for
30 minutes).

| Polarizing characteristics | | | |
|---|---|---|---|
| Transparency/Variation | Polarization/Variation | Shrinkage (%) | |
| (%) | (%) | MD | TD |
| 41.733/−0.065 | 99.908/−0.074 | 0.1 | 0.22 |

The test environments of the foregoing Tables 1 to 5 are reliability test environments often used in the manufacturing of polarizers. As seen in Tables 1 to 5, by using the blended cyclic olefin copolymer, the polarizer of the preferred embodiment certainly can have low photoelastic coefficient, high transparency, high humidity resistance and good size stability to temperature and humidity variations.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A polarizer, comprising:
an inner protection layer, wherein a material of the inner protection layer comprises a first blended cyclic olefin copolymer, and a blending ratio of cycloalkene monomer to ethylene of the first blended cyclic olefin copolymer determines mechanical properties of the inner protection layer;
an outer protection layer; and
a polarizing layer, positioned between the inner protection layer and the outer protection layer.

2. The polarizer of claim 1, wherein a material of the outer protection layer comprises triacetyl cellulose.

3. The polarizer of claim 1, wherein a material of the outer protection layer comprises a second blended cyclic olefin copolymer, and a blending ratio of cycloalkene monomer to ethylene of the second blended cyclic olefin copolymer determines mechanical properties of the outer protection layer.

4. The polarizer of claim 3, wherein the first and second blended cyclic olefin copolymers are of the same blending ratio.

5. The polarizer of claim 3, wherein the first and second blended cyclic olefin copolymers are of different blending ratios.

6. The polarizer of claim 1, wherein when the polarizer is an upper polarizer, an outside surface of the outer protection layer is a treated surface.

7. The polarizer of claim 6, wherein the treated surface is an anti-glare surface, an anti-reflection surface or a hard-coat surface.

8. The polarizer of claim 1, wherein when the polarizer is an upper polarizer or a lower polarizer, the inner protection layer has a retardation for a phase difference.

9. The polarizer of claim 1, wherein the polarizer further comprises a triacetyl cellulose protection layer positioned between the polarizing layer and the inner protection layer.

10. A method for manufacturing a polarizer, the method comprising:
selecting a first blended cyclic olefin copolymer, wherein the first blended cyclic olefin copolymer has a first blending ratio of cycloalkene monomer to ethylene;
making the first blended cyclic olefin copolymer into an inner protection layer; and
adhering the inner protection layer to a first side of a polarizing layer.

11. The method of claim 10, wherein the method further comprises:
adhering an outer protection layer to a second side of the polarizing layer.

12. The method of claim 11, wherein a material of the outer protection layer comprises triacetyl cellulose.

13. The method of claim 11, wherein the method further comprises:
making a second blended cyclic olefin copolymer into the outer protection layer, wherein the second blended cyclic olefin copolymer has a second blending ratio of cycloalkene monomer to ethylene.

14. The method of claim 13, wherein the first blending ratio is the same as the second blending ratio.

15. The method of claim 13, wherein the first blending ratio is different from the second blending ratio.

16. The method of claim 11, wherein when the polarizer is an upper polarizer, the method further comprises:
treating an outside surface of the outer protection layer by a surface treatment.

17. The method of claim 16, wherein the surface treatment is an anti-glare treatment, an anti-reflection treatment, a hard-coat treatment or any combination thereof.

18. The method of claim 10, wherein when the polarizer is an upper polarizer or a lower polarizer, the method further comprises:
extending the inner protection layer to make the inner protection layer have a retardation for a phase difference.

19. The method of claim 10, wherein the method further comprises:
baking the polarizer after adhering the inner protection layer to the polarizing layer.

20. The method of claim 10, wherein the method further comprises:
adhering a triacetyl cellulose protection layer between the polarizing layer and the inner protection layer.
